(19) United States
(12) Patent Application Publication
(10) Pub. No.: US 2024/0323593 A1
(43) Pub. Date: Sep. 26, 2024

(54) TRANSDUCERS AND HEADPHONES

(71) Applicant: SHENZHEN SHOKZ CO., LTD., Shenzhen (CN)

(72) Inventors: Lei ZHANG, Shenzhen (CN); Guangyuan ZHU, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 18/736,506

(22) Filed: Jun. 6, 2024

Related U.S. Application Data
(63) Continuation of application No. PCT/CN2022/106300, filed on Jul. 18, 2022.

(51) Int. Cl. H04R 1/28; H04R 1/10; H04R 7/06; H04R 9/02; H04R 9/04; H04R 9/06

(52) U.S. Cl. CPC H04R 1/2873; H04R 1/288; H04R 7/06; H04R 9/025; H04R 9/045; H04R 9/063; H04R 1/105

(57) ABSTRACT

The present disclosure relates to a transducer and a headphone. The transducer includes a magnetic circuit system, a coil, a first vibration transmitting plate, and a second vibration transmitting plate. The magnetic circuit system includes a magnet assembly. The coil is sleeved on an outside of the magnet assembly around an axis parallel to a vibration direction of the transducer. The first vibration transmitting plate and the second vibration transmitting plate elastically support the magnet assembly in the vibration direction from opposite sides of the magnet assembly, respectively. In the present disclosure, the magnet assembly is elastically supported by the first vibration transmitting plate and the second vibration transmitting plate in the vibration direction of the transducer from the opposite sides, respectively, to make it free of abnormal vibration, such as obvious shaking, which is conducive to increasing stability of vibration of the transducer.

### CROSS-REFERENCE TO RELATED APPLICATIONS

This application is a continuation of International Application No. PCT/CN2022/106300, filed on Jul. 18, 2022, the entire contents of which are incorporated herein by reference.

### TECHNICAL FIELD

The present disclosure relates to the technical field of electronic devices, in particular, to transducers and headphones.

### BACKGROUND

With the continuous popularization of electronic devices, electronic devices have become indispensable social and entertainment tools in people's daily lives. The requirements for electronic devices are also getting higher and higher. Electronic devices such as headphones have also been widely used in people's daily lives, which can be used in conjunction with cell phones, computers, and other terminal equipments to provide users with an auditory feast. According to the working principle, the headphones may be generally classified into air conduction headphones and bone conduction headphones. According to the way the user wears the headphones, the headphones may be generally classified into head-mounted headphones, ear-hook headphones, and in-ear headphones. According to the way of interaction between the headphones and the electronic devices, the headphones may be generally classified into wired headphones and wireless headphones.

### SUMMARY

Embodiments of the present disclosure provide a transducer including a magnetic circuit system, a coil, a first vibration transmitting plate, and a second vibration transmitting plate. The magnetic circuit system may include a magnet assembly. The coil may be sleeved on an outside of the magnet assembly around an axis that is parallel to a vibration direction of the transducer. The first vibration transmitting plate and the second vibration transmitting plate may elastically support the magnet assembly in the vibration direction from opposite sides of the magnet assembly, respectively.

Embodiments of the present disclosure provide a headphone including a support assembly and a core module connected to the support assembly. The support assembly may be configured to support the core module to be worn at a wearing position. The core module may include a core housing and the transducer as described in the above embodiment. The transducer is provided in an accommodating cavity of the core housing.

The beneficial effect of the present disclosure is that, compared with the related technology in which the magnet assembly is constrained on one side, in the present disclosure, the magnet assembly is elastically supported by the first vibration transmitting plate and the second vibration transmitting plate in the vibration direction of the transducer from the opposite sides, respectively, to make it free of abnormal vibration, such as obvious shaking, which is conducive to increasing stability of vibration of the transducer.

### BRIEF DESCRIPTION OF THE DRAWINGS

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may obtain other drawings according to these drawings.

FIG. 1 is a schematic diagram illustrating wearing headphones according to some embodiments of the present disclosure;

FIG. 2 is a schematic diagram illustrating a structure of a core module according to an embodiment of the present disclosure;

FIG. 3 is a schematic diagram illustrating a structure of a headphone according to an embodiment of the present disclosure;

FIG. 4 is a schematic diagram illustrating a structure of a headphone according to an embodiment of the present disclosure;

FIG. 5 is a schematic diagram illustrating a structure of a headphone according to an embodiment of the present disclosure;

FIG. 6 is a schematic diagram illustrating a structure of a headphone according to an embodiment of the present disclosure;

FIG. 7 is a schematic diagram illustrating a structure of a headphone according to an embodiment of the present disclosure;

FIG. 8 is a schematic diagram illustrating a top view of a structure of a first vibration transmitting plate according to an embodiment of the present disclosure;

FIG. 9 is a schematic diagram illustrating a top view of a structure of a second vibration transmitting plate according to an embodiment of the present disclosure;

FIG. 10 is a schematic diagram illustrating a top view of a structure of a first vibration transmitting plate according to an embodiment of the present disclosure;

FIG. 11 is a schematic diagram illustrating a top view of a structure of a second vibration transmitting plate according to an embodiment of the present disclosure;

FIG. 12 is a schematic diagram illustrating vibration test results of a transducer according to an embodiment of the present disclosure; and

FIG. 13 is a schematic diagram illustrating frequency response curves of headphones according to some embodiments of the present disclosure.

### DETAILED DESCRIPTION

The present disclosure is now described in further detail in connection with the accompanying drawings. In particular, it is noted that the following embodiments are only used to illustrate the present disclosure, but do not limit the scope of the present disclosure. Similarly, the following embodiments are only part of the embodiments of the present disclosure rather than all of the embodiments, and all other embodiments obtained by a person of ordinary skill in the art without creative labor fall within the scope of protection of the present disclosure.

References to “embodiments” in the present disclosure mean that particular features, structures, or characteristics described in conjunction with embodiments may be included in at least one embodiment of the present disclosure. It is understood by those of skill in the art, both explicitly and implicitly, that the embodiments described in the present disclosure may be combined with other embodiments.

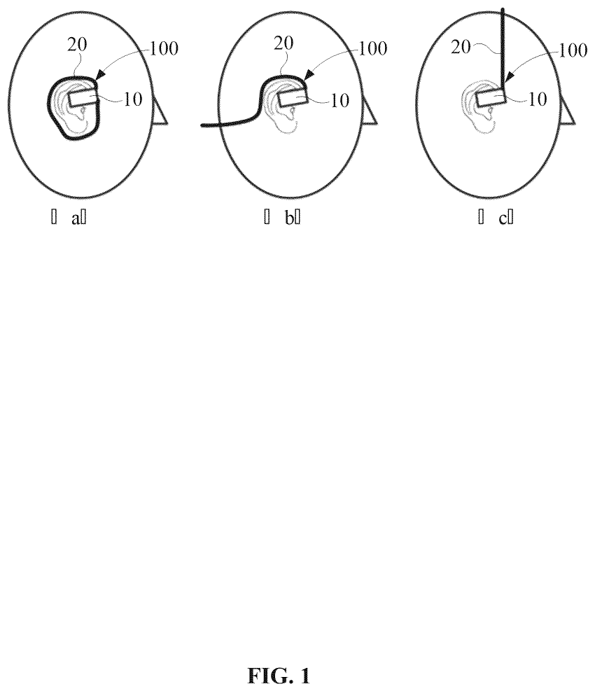

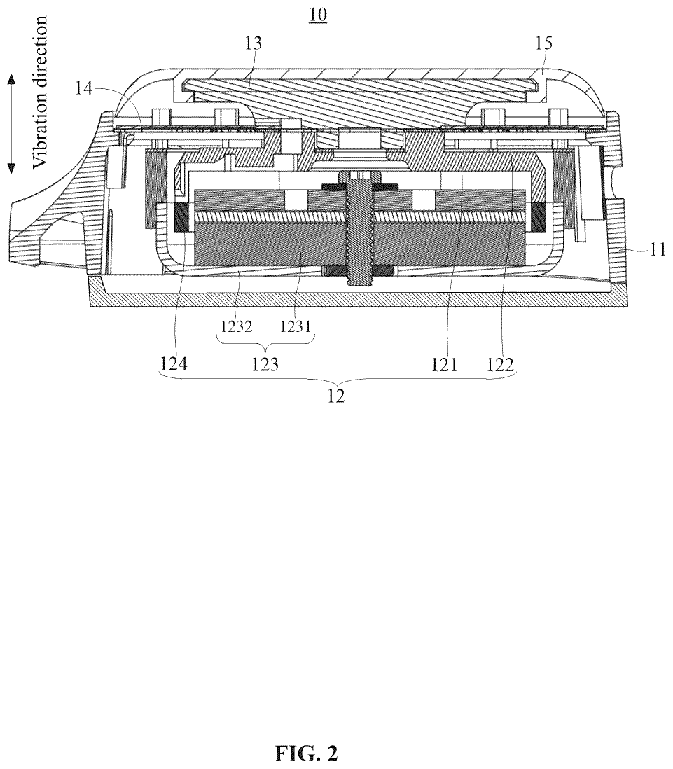

FIG. 1 is a schematic diagram illustrating wearing headphones according to some embodiments of the present disclosure. FIG. 2 is a schematic diagram illustrating a structure of a core module according to an embodiment of the present disclosure.

In this embodiment, the headphone 100 may be an electronic device such as a music headphone, a hearing aid headphone, a bone conduction headphone, a hearing aid, an audio glasses, a VR device, an AR device, or the like.

In conjunction with FIG. 1, the headphone 100 may include a core module 10 and a support assembly 20, and the core module 10 is connected to the support assembly 20. The core module 10 may convert an electrical signal into a mechanical vibration so that a user can hear sounds through the headphone 100. The support assembly 20 may support the core module 10 to be worn at a wearing position. The wearing position may be a specific position on the user's head. For example, The wearing position may be the mastoid, temporal bone, parietal, frontal, etc., on the head. As another example, the wearing position may be a position on the left or right side of the head and at a front side of the user's ear on a sagittal axis of the human body. In some embodiments, the vibration generated by the core module 10 may be transmitted via a medium such as the user's skull (i.e., bone conduction) to form bone-conducted sound, or may be transmitted via a medium such as air (i.e., air conduction) to form air-conducted sound. The support assembly 20 may be provided in a ring shape and provided around the user's ear, as shown in (a) of FIG. 1. The support assembly 20 may also be provided as an ear hook and rear hook structure cooperating to be provided around a rear side of the head, as shown in (b) of FIG. 1. The support assembly 20 may be provided as a headband structure and provided around a top of the user's head, as shown in (c) of FIG. 1.

It should be noted that two core module 10 described in the present disclosure may be provided, and the two core modules 10 may convert the electrical signal into the core vibration. This is mainly to facilitate the headphone 100 to realize stereo sound effects. In some other application scenarios where stereo sound is not highly required, such as hearing aids for hearing patients, hosts' live teleprompter, or the like, the headphone 100 may also be provided with only one core module 10.

Merely by way of example, the support assembly 20 may include two ear hook assemblies and a rear hook assembly. Two ends of the rear hook assembly are connected to one end of a corresponding ear hook assembly, and another end of each of the two ear hook assemblies away from the rear hook assembly is connected to a corresponding core module 10. In some embodiments, the rear hook assembly may be provided in a curved shape for wrapping around the rear side of the user's head, and the ear hook assemblies may be provided in a curved shape for hanging between the user's ear and the user's head, thereby facilitating the wearing of the headphone. In such a case, when the headphone 100 is in a wearing state, the two core modules 10 may be located on a left side and a right side of the user's head, respectively. The two core modules 10 may also cooperate with the support assembly 20 to hold onto the user's head. Thus the user may hear the sound output from the headphone 100.

In conjunction with FIG. 2, the core module 10 may include a core housing 11, a transducer 12, and a vibration panel 13. The transducer 12 may be provided in an accommodating cavity of the core housing 11, and the vibration panel 13 may be connected to the transducer 12 for transmitting the mechanical vibration generated by the transducer 12 to the user. The transducer 12 is configured to convert the electrical signal into the mechanical vibration in an energized state. In the wearing state, the vibration panel 13 may contact the skin of the user to act on the auditory nerves of the user by using the bones and tissues of the user as media, thereby creating bone conduction sound.

In some embodiments, the core module 10 may also include a vibration-damping sheet 14. The transducer 12 may be suspended within the accommodating cavity of the core housing 11 via the vibration-damping sheet 14, i.e., edges of the vibration panel 13 are disconnected from an open end of the core housing 11. At this time, due to the presence of the vibration-damping sheet 14, the mechanical vibration generated by the transducer 12 may be less or even not transmitted to the core housing 11, thereby preventing the core housing 11 from driving the air vibration outside the headphone 100 to a certain extent. Certainly, to reduce the sound leakage of the headphone 100, the core housing 11 may also be provided at least one through hole (commonly known as the “sound leakage reduction hole”) for connecting the accommodating cavity of the core housing 11 and an exterior of the headphone 100. Relevant principles and structures are well known by the technical personnel in the field, and may not be repeated here.

In some embodiments, the core module 10 may further include a face-fitting sleeve 15 connected to the vibration panel 13. The face-fitting sleeve 15 is configured to contact the skin of the user, i.e., the vibration panel 13 may contact the skin of the user through the face-fitting sleeve 15. The Shore hardness of the face-fitting sleeve 15 may be less than the Shore hardness of the vibration panel 13, i.e., the face-fitting sleeve 15 may be softer than the vibration panel 13. For example, the face-fitting sleeve 15 is made of a soft material such as silicone, and the vibration panel 13 is made of a hard material such as polycarbonate, fiberglass-reinforced plastic, etc. Thus, the wearing comfort of the headphone 100 is improved and the core module 10 fits more closely to the skin of the user, which in turn improves the sound quality of the headphone 100. Furthermore, the face-fitting sleeve 15 may be detachably connected to the vibration panel 13 for replacement by the user.

Exemplarily, the transducer 12 may include a bracket 121, a vibration transmitting plate 122, a magnetic circuit system 123, and a coil 124. The vibration transmitting plate 122 may connect the bracket 121 to the magnetic circuit system 123 to suspend the magnetic circuit system 123 within the accommodating cavity of the core housing 11, and the coil 124 may extend into a magnetic gap of the magnetic circuit system 123 along a vibration direction of the transducer 12. The magnetic circuit system 123 may include a magnet assembly 1231 and a magnetic conducting cover 1232. The magnet assembly 1231 is fixed to a bottom of the magnetic conducting cover 1232, and a sidewall of the magnetic conducting cover 1232 and the magnet assembly 1231 are spaced apart in a direction perpendicular to the vibration direction of the transducer 12 to form the magnetic gap. In other words, the magnetic conducting cover 1232 may be a tubular structure with an end open. In some embodiments, the coil 124 may be connected to the bracket 121, and the sidewall of the magnetic conducting cover 1232 may be connected to the vibration transmitting plate 122. Correspondingly, the vibration-damping sheet 14 may connect the bracket 121 to the core housing 11 to suspend the transducer 12 in the accommodating cavity of the core housing 11, and the vibration panel 13 may be connected to the bracket 121.

It is worth noting that in the core module 10 shown in FIG. 2, the magnet assembly 1231 is fixed to the magnetic conducting cover 1232 through a one-sided connection, i.e., one side of the magnet assembly 1231 is constrained and another side is not constrained to allow the coil 124 to move relative to the magnetic circuit system 123. In the vibration direction of the transducer 12, a distance needs to exist between the coil 124 and the bottom of the magnetic conducting cover 1232 to avoid collision between the two. In the direction perpendicular to the vibration direction of the transducer 12, a distance between the coil 124 and the magnet assembly 1231 and a distance between the coil 124 and the magnetic conducting cover 1232 need to exist, to avoid collision of the coil 124 with either of the magnet assembly 1231 and the magnetic conducting cover 1232. During the vibration of the transducer 12, the coil 124 and the magnetic circuit system 123 not only have a relative movement along the vibration direction, but may also have a tendency to twist around the vibration direction, resulting in the magnetic gap of the magnetic circuit system 123 becoming larger to a certain extent to avoid unnecessary collisions.

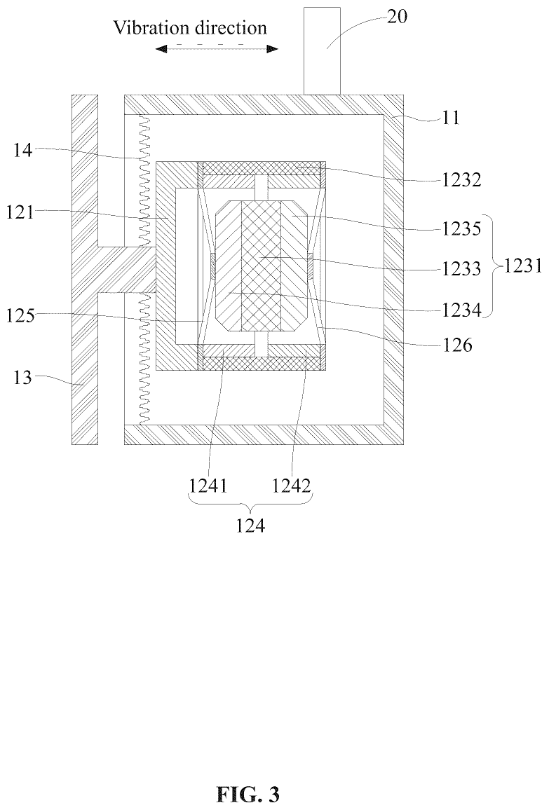

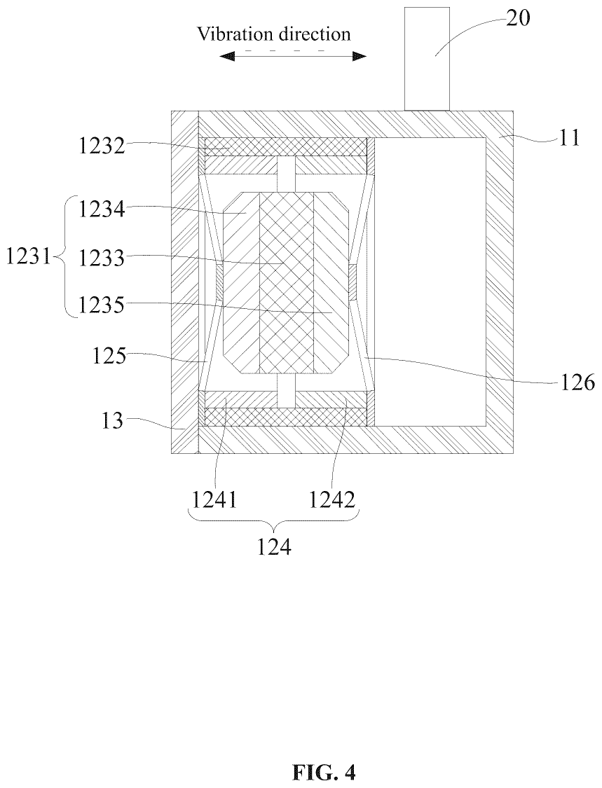

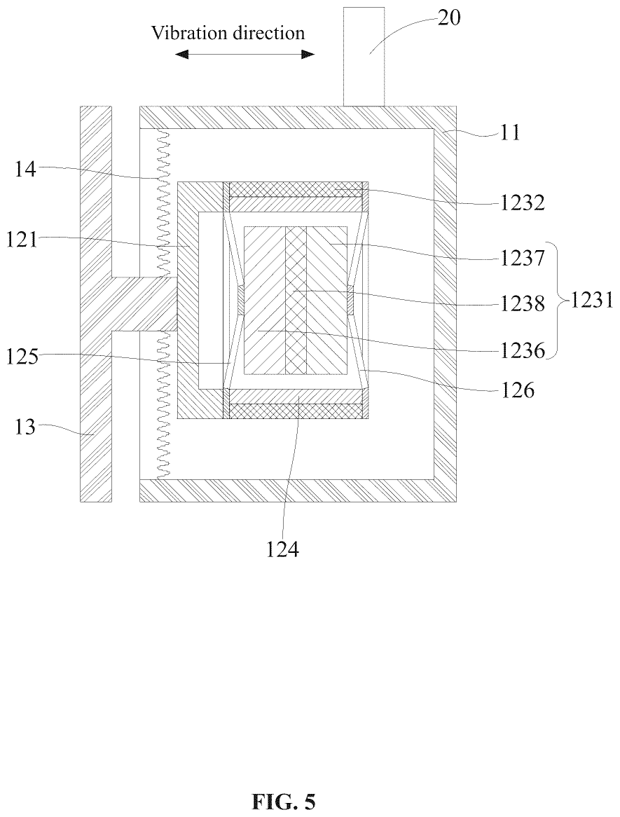

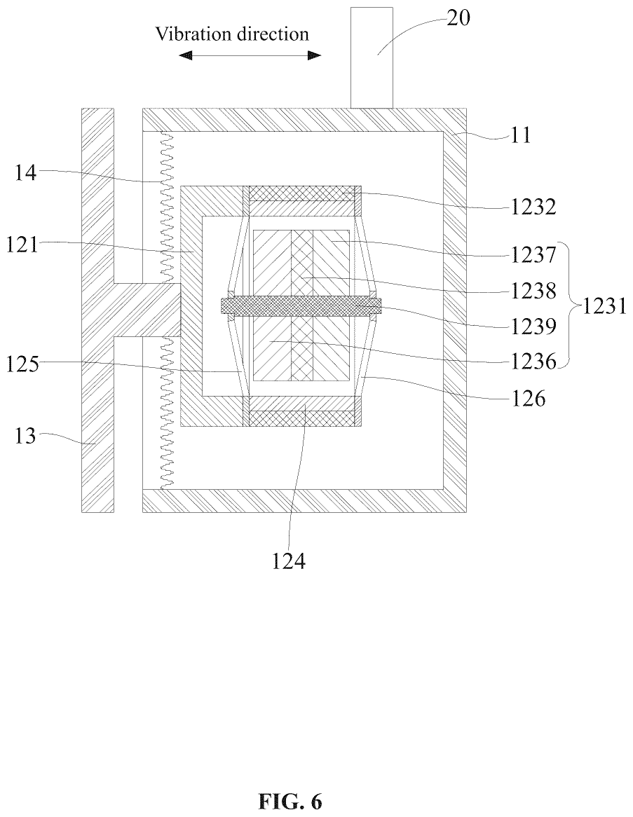

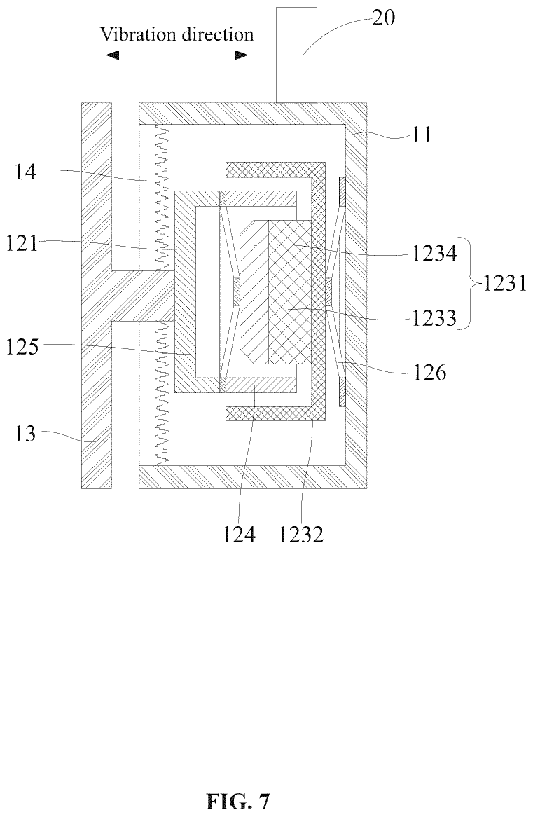

Referring to FIG. 3 to FIG. 7, FIG. 3 is a schematic diagram illustrating a structure of a headphone according to an embodiment of the present disclosure. FIG. 4 is a schematic diagram illustrating a structure of a headphone according to an embodiment of the present disclosure. FIG. 5 is a schematic diagram illustrating a structure of a headphone according to an embodiment of the present disclosure. FIG. 6 is a schematic diagram illustrating a structure of a headphone according to an embodiment of the present disclosure. FIG. 7 is a schematic diagram illustrating a structure of a headphone according to an embodiment of the present disclosure.

The main difference with the above embodiment is that, in this embodiment, in combination with at least one of FIG. 3 to FIG. 7, the transducer 12 may include a magnetic circuit system 123, a coil 124, a first vibration transmitting plate 125, and a second vibration transmitting plate 126. The magnetic circuit system 123 may include a magnet assembly 1231, and the coil 124 may be sleeved on an outside of the magnet assembly 1231 around an axis parallel to a vibration direction of the transducer 12. In the vibration direction of the transducer 12, the first vibration transmitting plate 125 and the second vibration transmitting plate 126 may elastically support the magnet assembly 1231 from opposite sides of the magnet assembly 1231 respectively. In such a case, compared to the magnet assembly 1231 being constrained on one side, the magnet assembly 1231 is elastically supported on the opposite sides along the vibration direction of the transducer 12, so that there is no abnormal vibration such as obvious shaking, which is conducive to increasing the stability of the vibration of the transducer 12.

In some embodiments, in combination with any one of FIG. 3 to FIG. 6, the magnetic circuit system 123 may further include a magnetic conducting cover 1232. The magnetic conducting cover 1232 may be sleeved on an outside of the coil 124 around an axis parallel to the vibration direction of the transducer 12, i.e., the magnetic conducting cover 1232 and the magnet assembly 1231 are spaced apart in a direction perpendicular to the vibration direction of the transducer 12. An edge region of the first vibration transmitting plate 125 and an edge region of the second vibration transmitting plate 126 may be connected to two ends of the magnetic conducting cover 1232, respectively. In other words, the magnetic conducting cover 1232 may be a tubular structure with two ends open. In such a case, as compared to the magnetic conducting cover 1232 being a tubular structure with an end open, the magnetic conducting cover 1232 in the present embodiment is a tubular structure with two ends open, which is conducive to eliminating the acoustic cavity effect of the magnetic circuit system 123, thereby reducing the sound leakage of the headphone 100. In conjunction with FIG. 2, the acoustic cavity effect mainly originates from the fact that the magnet assembly 1231 and the magnetic conducting cover 1232 form a semi-enclosed cavity, and that the coil 124, when moving relative to the magnetic circuit system 123, acts on the air in the semi-enclosed cavity, causing a change in air pressure and generating the sound leakage. Correspondingly, the coil 124 may extend into the magnetic gap between the magnet assembly 1231 and the magnetic conducting cover 1232. Certainly, in other embodiments, such as those in which the concentration of the magnetic field generated by the magnet assembly 1231 is not highly required, the magnetic conducting cover 1232 may be replaced with a non-magnetic member such as a plastic bracket. In such a case, the edge region of the first vibration transmitting plate 125 and the edge region of the second vibration transmitting plate 126 may be connected to two ends of the plastic bracket, respectively.

In some other embodiments, in conjunction with FIG. 7, the magnetic circuit system 123 may also include the magnetic conducting cover 1232 spaced apart from the magnet assembly 1231 in the direction perpendicular to the vibration direction of the transducer 12, and the magnet assembly 1231 is connected to the bottom of the magnetic conducting cover 1232. One of the first vibration transmitting plate 125 and the second vibration transmitting plate 126 may be connected to the vibration panel 13, and another one may be connected to the core housing 11 to suspend the magnetic circuit system 123 within the core housing 11. For example, a center region of the first vibration transmitting plate 125 is connected to the magnet assembly 1231, and the edge region of the first vibration transmitting plate 125 is connected to the vibration panel 13 via the bracket 121. One of a center region and the edge region of the second vibration transmitting plate 126 is connected to the magnet assembly 1231 via the magnetic conducting cover 1232, and another one is connected to the core housing 11. As another example, the center region of the first vibration transmitting plate 125 is connected to the vibration panel 13 via the bracket 121, and the edge region of the first vibration transmitting plate 125 is connected to the magnet assembly 1231 via the magnetic conducting cover 1232. In other words, similar to FIG. 2, the magnetic conducting cover 1232 may also be a tubular structure with an open end. Correspondingly, the coil 124 may extend into the magnetic gap between the magnet assembly 1231 and the magnetic conducting cover 1232.

In the above-described manner, regardless of whether the magnetic circuit system 123 includes the magnetic conducting cover 1232 or a plastic bracket that replaces the magnetic conducting cover 1232, since the first vibration transmitting plate 125 and the second vibration transmitting plate 126 constrain the magnet assembly 1231 from two sides in the vibration direction of the transducer 12, the vibration of the transducer 12 may be more stable.

In some embodiments, in the natural state of the first vibration transmitting plate 125 and the second vibration transmitting plate 126, the edge region of the first vibration transmitting plate 125 may be non-coplanar with the center region of the first vibration transmitting plate 125, and the edge region of the second vibration transmitting plate 126 may be non-coplanar with the center region of the second vibration transmitting plate 126 to provide a preload force after the first vibration transmitting plate 125 and the second vibration transmitting plate 126 are connected to the magnet assembly 1231, respectively. The magnet assembly 1231 may specifically be the first magnet 1236 and the second magnet 1237 mentioned hereinafter, or the first magnetic guiding plate 1234 and the second magnetic guiding plate 1235 mentioned hereinafter. As used herein, the natural state described in the present disclosure refers to a structural state in which the first vibration transmitting plate 125 and the second vibration transmitting plate 126 are assembled to the transducer 12, no excitation signal is input to the transducer 12 and no mechanical vibration is generated. In such a case, due to the presence of the preload force, the first vibration transmitting plate 125 and the second vibration transmitting plate 126 may not simultaneously experience a situation in which the elasticity is zero during vibration of the transducer 12, which is conducive to improving stability and linearity of the vibration of the transducer 12. Thus, the first vibration transmitting plate 125 and the second vibration transmitting plate 126 may be planar before being assembled to the transducer 12 to facilitate processing.

Merely by way of example, in the natural state, a first distance between the edge region of the first vibration transmitting plate 125 and the center region of the first vibration transmitting plate 125 in an axial direction of the first vibration transmitting plate 125 may be greater than or equal to 0.4 mm, and a second distance between the edge region of the second vibration transmitting plate 126 and the center region of the second vibration transmitting plate 126 in the axial direction of the second vibration transmitting plate 126 may be greater than or equal to 0.4 mm. If the first distance and the second distance are too small, it is easy to cause the preload force provided by the first vibration transmitting plate 125 and the second vibration transmitting plate 126 to be too small to meet the actual use requirements, and it is also easy to cause the first vibration transmitting plate 125 and the second vibration transmitting plate 126 to structurally interfere with the magnet assembly 1231 during the vibration of the transducer 12. In some embodiments, the first distance and the second distance may be equal.

In some embodiments, in conjunction with FIG. 6, in the vibration direction of the transducer 12, the center region of the first vibration transmitting plate 125 may be further away from the magnet assembly 1231 compared to the edge region thereof. The center region of the second vibration transmitting plate 126 may be further away from the magnet assembly 1231 compared to the edge region thereof. In such a case, it is conducive to assemble the first vibration transmitting plate 125 and the second vibration transmitting plate 126 in the transducer 12. For example, the magnetic circuit system 123 may also include a connecting member 1239 threaded through the magnet assembly 1231. The length of the connecting member 1239 in the vibration direction of the transducer 12 is greater than the thickness of the magnet assembly 1231 in the vibration direction of the transducer 12. The center regions of the first vibration transmitting plate 125 and the second vibration transmitting plate 126 may be fixed at two ends of the connecting member 1239, respectively. In this way, the connecting member 1239 may spread the first vibration transmitting plate 125 and the second vibration transmitting plate 126 apart in the vibration direction of the transducer 12.

It should be noted that after the first vibration transmitting plate 125 and the second vibration transmitting plate 126 are assembled in the transducer 12 with a preset preload force, the edge region of the first vibration transmitting plate 125 and the edge region of the second vibration transmitting plate 126 may be coplanar with their corresponding center regions, respectively, as shown in FIG. 3-FIG. 6. The edge region of the first vibration transmitting plate 125 and the edge region of the second vibration transmitting plate 126 may also be coplanar with their corresponding center regions, respectively.

In some embodiments, as shown in any one of FIG. 3, FIG. 5, and FIG. 6, the magnetic conducting cover 1232 may be connected to the bracket 121. The bracket 121 may be connected to the core housing 11 via the vibration-damping sheet 14 to suspend the transducer 12 within the accommodating cavity of the core housing 11. At this point, the vibration panel 13 may be connected to the bracket 121 and disconnected from the open end of the core housing 11. Further, a ratio of the stiffness of the vibration-damping sheet 14 to the stiffness of the first vibration transmitting plate 125 may be within a range of 0.1-5, and a ratio of the stiffness of the vibration-damping sheet 14 to the stiffness of the second vibration transmitting plate 126 may be within a range of 0.1-5. If the stiffness of the vibration-damping sheet 14 is too small, it is difficult for the magnetic circuit system 123 to be stably suspended in the core housing 11 by the vibration-damping sheet 14, which tends to result in poorer stability of the transducer 12 when it is vibrating. Conversely, if the stiffness of the vibration-damping sheet 14 is too large, the vibration of the transducer 12 is easily transmitted to the core housing 11 via the vibration-damping sheet 14, which is likely to lead to excessive sound leakage of the headphone 100.

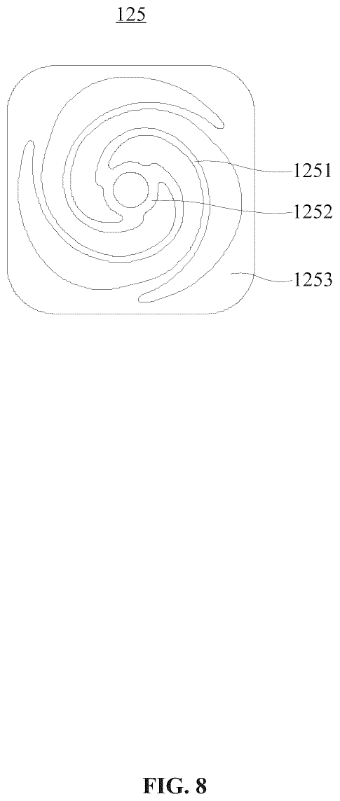

It should be noted that the stiffness of the structures such as the vibration-damping sheet 14, the first vibration transmitting plate 125, and the second vibration transmitting plate 126 described in the present disclosure may be measured in the same or similar manner. In order to facilitate the description of the manner for measuring the stiffness, the first vibration transmitting plate 125 shown in FIG. 8 is illustrated as an example. First, an edge (e.g., a first outer fixing portion 1253) of the first vibration transmitting plate 125 is fixed to a fixing table of a tester such as a klystron, and the probe of the klystron is aligned with a test point (e.g., a first inner fixing portion 1252) such as a centroid or a geometric center of the first vibration transmitting plate 125. Then a plurality of values for displacement on the control panel of the klystron are input, and a corresponding relationship between parameters such as force and displacement of the probe is recorded, to plot a displacement-force curve (whose horizontal and vertical axes denote the displacements and the forces, respectively). Finally, a slope of an inclined straight line segment of the curve is calculated to obtain the stiffness of the first vibration transmitting plate 125. Each displacement may represent a distance moved by the probe, the movement of the probe may cause a deformation of the first vibration transmitting plate 125, and the deformation of the first vibration transmitting plate 125 caused by each displacement may not exceed a maximum deformation of the first vibration transmitting plate 125. Furthermore, due to the deformation of the first vibration transmitting plate 125 lags behind the movement of the probe, the displacement-force curve may have a curve segment nearly parallel to a horizontal axis, which may be disregarded in calculating the stiffness of the first vibration transmitting plate 125.

In some other embodiments, as shown in FIG. 4, the edge region of any one of the first vibration transmitting plate 125 and the second vibration transmitting plate 126 may be connected to the open end of the core housing 11 by assembling manners, such as snapping, gluing, etc., or a combination thereof. Certainly, the vibration panel 13 and the core housing 11 may also be integrally molded structural members of the same material.

Furthermore, in the direction perpendicular to the vibration direction of the transducer 12, a gap between the coil 124 and the magnetic conducting cover 1232 may be smaller than a gap between the coil 124 and the magnet assembly 1231. In this way, distances need to exist between the coil 124 and the transducer 12 and the magnetic conducting cover 1232, respectively in the direction perpendicular to the vibration direction of the transducer 12. In the present disclosure, the magnet assembly 1231 is elastically supported on two opposite sides of the magnet assembly 1231 in the vibration direction of the transducer 12, so that there is no need to worry about the collision of the coil 124 with the magnetic conducting cover 1232, which is conducive to reducing the magnetic gap between the magnet assembly 1231 and the magnetic conducting cover 1232 in the direction perpendicular to the vibration direction of the transducer 12. Therefore, a connecting area between the above semi-closed cavity and the exterior of the magnetic circuit system 123 may be reduced, hindering the propagation path of the sound leakage generated by the acoustic cavity effect, i.e., suppressing the acoustic cavity effect, thereby reducing the sound leakage of the headphone 100. The coil 124 may be fixed to the magnetic conducting cover 1232, i.e., the magnetic conducting cover 1232 may be kept in movement with the coil 124. In this way, not only is it beneficial to further reduce the magnetic gap in the direction perpendicular to the vibration direction of the transducer 12, but it also permits the magnetic conducting cover 1232 to double as a short-circuit loop for the coil 124, which is beneficial to reduce the inductance of the coil 124 and facilitates heat dissipation of the transducer 12.

In some embodiments, as shown in FIG. 3 and FIG. 4, the magnet assembly 1231 may include a magnet 1233, a first magnetic guiding plate 1234 and a second magnetic guiding plate 1235 located on two opposite sides of the magnet 1233 in the vibration direction of the transducer 12. The first vibration transmitting plate 125 may support the magnet assembly 1231 from a side of the first magnetic guiding plate 1234 away from the second magnetic guiding plate 1235, and the second vibration transmitting plate 126 may support the magnet assembly 1231 from a side of the second magnetic guiding plate 1235 away from the first magnetic guiding plate 1234. For example, the center region of the first vibration transmitting plate 125 is connected to the side of the first magnetic guiding plate 1234 away from the second magnetic guiding plate 1235. The center region of the second vibration transmitting plate 126 is connected to the side of the second magnetic guiding plate 1235 away from the first magnetic guiding plate 1234. Edges of two opposite sides of the first magnetic guiding plate 1234 and the second magnetic guiding plate 1235 may be chamfered to adjust the distribution of the magnetic field formed by the magnetic circuit system 123.

Similar to the embodiment illustrated in FIG. 5 or FIG. 6, two magnets may also be clamped between the first magnetic guiding plate 1234 and the second magnetic guiding plate 1235 in the vibration direction of the transducer 12, and magnetization directions of the two magnets may be different. For example, the two magnets have the same polarity at one end facing each other and the magnetization directions are perpendicular to a junction of the two magnets.

Furthermore, in the vibration direction of the transducer 12, a half-thickness location (i.e., a location at half the thickness) of the magnet assembly 1231 is at the same height as a half-height location (i.e., a location at half the height) of the coil 124. In such a case, it is beneficial for the magnetic field formed by the magnetic circuit system 123 to pass through the coil 124 in an even and concentrated manner.

Exemplarily, the coil 124 may include a first coil 1241 connected to a side of the first vibration transmitting plate 125 towards the second vibration transmitting plate 126 and a second coil 1242 connected to a side of the second vibration transmitting plate 126 towards the first vibration transmitting plate 125, and a current direction in the first coil 1241 is opposite to a current direction in the second coil 1242. In other words, the transducer 12 vibrates with the drive of two coils, which facilitates increasing the magnitude of the vibration of the transducer 12. In the vibration direction of the transducer 12, since a thickness of the first magnetic guiding plate 1234 and a thickness of the second magnetic guiding plate 1235 are generally equal, a half-height location of the first coil 1241 may be at the same height as a half-thickness location of the first magnetic guiding plate 1234, and a half-height location of the second coil 1242 may be at the same height as a half-thickness location of the second magnetic guiding plate 1235. Therefore, the magnetic field adjusted by the first magnetic guiding plate 1234 and the second magnetic guiding plate 1235 may uniformly and centrally pass through the first coil 1241 and the second coil 1242, respectively. Similarly, a gap between the first coil 1241 and the magnetic conducting cover 1232 in the direction perpendicular to the vibration direction of the transducer 12 may be less than a gap between the first coil 1241 and the first magnetic guiding plate 1234 in the direction perpendicular to the vibration direction of the transducer 12. A gap between the second coil 1242 and the magnetic conducting cover 1232 in the direction perpendicular to the vibration direction of the transducer 12 may be less than a gap between the second coil 1242 with the second magnetic guiding plate 1235 in the direction perpendicular to the vibration direction of the transducer 12. For example, the first coil 1241 and the second coil 1242 are respectively fixed to the magnetic conducting cover 1232.

In some other embodiments, as shown in FIG. 5 or FIG. 6, the magnet assembly 1231 may include a first magnet 1236 and a second magnet 1237 stacked along the vibration direction of the transducer 12. A magnetization direction of the first magnet 1236 and a magnetization direction of the second magnet 1237 are different. For example, the magnetization direction of the first magnet 1236 is opposite to the magnetization direction of the second magnet 1237, and the magnetization direction of the first magnet 1236 and the magnetization direction of the second magnet 1237 are perpendicular to a junction of the two. In the vibration direction of the transducer 12, the first vibration transmitting plate 125 may elastically support the magnet assembly 1231 from a side of the first magnet 1236 away from the second magnet 1237, and the second vibration transmitting plate 126 may elastically support the magnet assembly 1231 from a side of the second magnet 1237 away from the first magnet 1236. For example, the center region of the first vibration transmitting plate 125 is connected to the side of the first magnet 1236 away from the second magnet 1237, and the center region of the second vibration transmitting plate 126 is connected to the side of the second magnet 1237 away from the first magnet 1236. In such a case, when the coil 124 is projected orthogonally to an outer peripheral surface of the magnet assembly 1231 in the direction perpendicular to the vibration direction of the transducer 12, a projection of the coil 124 overlaps with the junction of the first magnet 1236 and the second magnet 1237. Thus, it is advantageous for the magnetic field formed by the magnetic circuit system 123 to pass through the coil 124 in an even and concentrated manner.

Further, the magnet assembly 1231 may also include a magnetic guiding plate 1238 clamped between the first magnet 1236 and the second magnet 1237. When the coil 124 is projected orthogonally to the outer peripheral surface of the magnet assembly 1231 in the direction perpendicular to the vibration direction of the transducer 12, the projection of the coil 124 overlaps with a lateral peripheral surface of the magnetic guiding plate 1238. In such a case, the magnetization direction of the first magnet 1236 may be opposite to the magnetization direction of the second magnet 1237 and both are perpendicular to a surface of the magnetic guiding plate 1238 towards the first magnet 1236 or the second magnet 1237. In this way, it is beneficial for the magnetic field formed by the magnetic circuit system 123 to be concentrated within it, reducing magnetic leakage. Similarly, in the vibration direction of the transducer 12, the magnetic guiding plate 1238 may be located at the half-height location of the coil 124.

Similar to the embodiment shown in FIG. 3 or FIG. 4, in the vibration direction of the transducer 12, two magnetic guiding plates may be respectively provided on two sides of the first magnet 1236 and the second magnet 1237 opposite to each other, which is beneficial for further reducing the magnetic leakage.

Further, two ends of the coil 124 may be connected to the first vibration transmitting plate 125 and the second vibration transmitting plate 126, respectively, i.e., in the vibration direction of the transducer 12, the height of the coil 124 may be greater than or equal to the thickness of the magnet assembly 1231. In this way, as compared to the case that there is a distance between the coil 124 and the bottom of the magnetic conducting cover 1232 in the vibration direction of the transducer 12, in the present disclosure, the magnet assembly 1231 is elastically supported on two opposite sides of the magnet assembly 1231 in the vibration direction of the transducer 12, so that there is no need to worry about the collision of the coil 124 with the magnetic conducting cover 1232, so as to allow the height of the coil 124 to be increased in the vibration direction of the transducer 12, which is conducive to increasing an overlap area between the coil 124 and the magnet assembly 1231 in the direction perpendicular to the vibration direction of the transducer 12, thus increasing a utilization rate of the magnetic field of the magnetic circuit system 123 and improving the sensitivity and reliability of the transducer 12.

Furthermore, relationships between a height along the vibration direction of an overlapping region formed by orthographic projections of the magnet assembly 1231, the coil 124, and the magnetic conducting cover 1232 along the direction perpendicular to the vibration direction of the transducer 12 and heights of the magnet assembly 1231, the coil 124, and the magnetic conducting cover 1232 in the vibration direction may to some extent affect the distribution and utilization efficiency of the magnetic field of the magnetic circuit system 123.

In some embodiments, a ratio of the height, along the vibration direction, of the overlapping region formed by orthographic projections of the magnet assembly 1231, the coil 124, and the magnetic conducting cover 1232 along the direction perpendicular to the vibration direction of the transducer 12 to the height of the magnet assembly 1231 in the vibration direction may be within a range of 0.15-0.5. In such a case, the coil 124 may primarily utilize a relatively concentrated and homogeneous portion of the magnetic field generated by the magnet assembly 1231, which is conducive to increasing the stability of the vibration of the transducer 12.

In some other embodiments, a ratio of the height, along the vibration direction, of the overlapping region formed by orthographic projections of the magnet assembly 1231, the coil 124, and the magnetic conducting cover 1232 along the direction perpendicular to the vibration direction of the transducer 12 to the height of the coil 124 in the vibration direction may be within a range of 0.53-0.83. In this way, the magnetic field formed by the magnetic circuit system 123 may pass more through the coil 124, which facilitates increasing the utilization rate of the magnetic field of the magnetic circuit system 123.

In other alternative embodiments, a ratio of the height, along the vibration direction, of the overlapping region formed by orthographic projections of the magnet assembly 1231, the coil 124, and the magnetic conducting cover 1232 along the direction perpendicular to the vibration direction of the transducer 12 to the height of the magnetic conducting cover 1232 in the vibration direction may be within a range of 0.12-0.32. In this way, the magnetic conducting cover 1232 may ensure more relatively concentrated and uniform portions in the magnetic field generated by the magnet assembly 1231, which is conducive to increasing the stability of the vibration of the transducer 12.

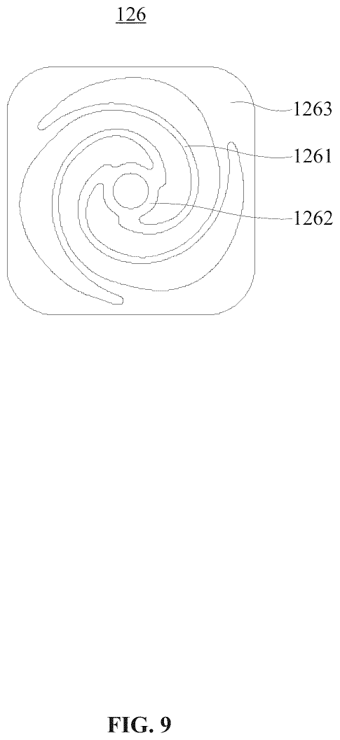

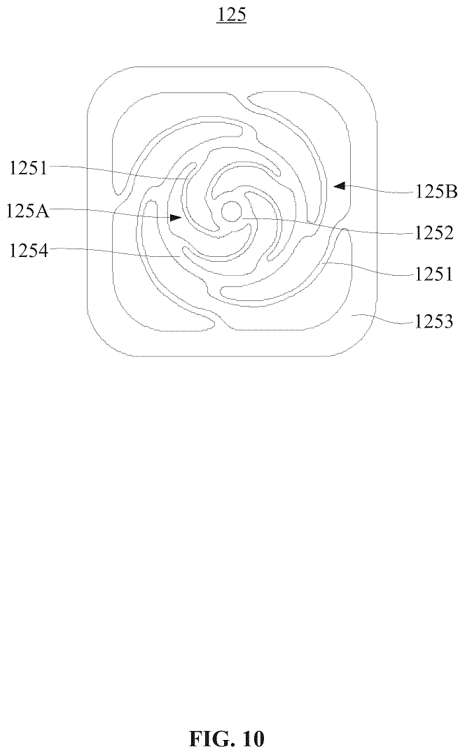

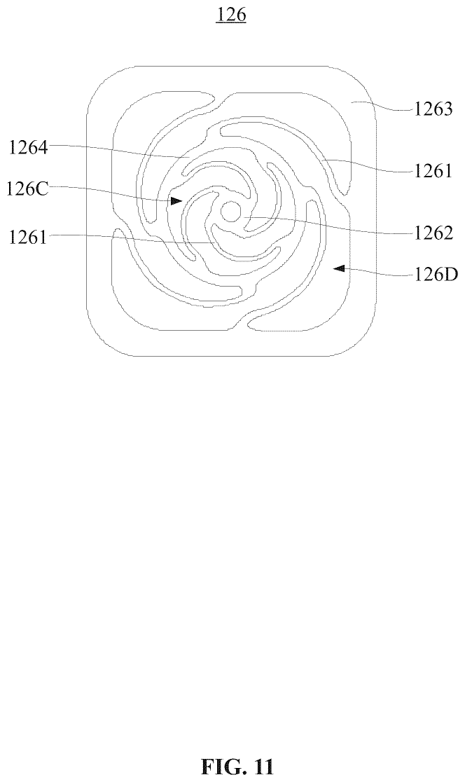

Referring together to FIG. 8 to FIG. 11, FIG. 8 is a schematic diagram illustrating a top view of a structure of a first vibration transmitting plate according to an embodiment of the present disclosure. FIG. 9 is a schematic diagram illustrating a top view of a structure of a second vibration transmitting plate according to an embodiment of the present disclosure. FIG. 10 is a schematic diagram illustrating a top view of a structure of a first vibration transmitting plate according to an embodiment of the present disclosure. FIG. 11 is a schematic diagram illustrating a top view of a structure of a second vibration transmitting plate according to an embodiment of the present disclosure.

In conjunction with FIG. 8 and FIG. 9, the first vibration transmitting plate 125 may include a first spoke portion 1251, and a first inner fixing portion 1252 and a first outer fixing portion 1253 connected to the first spoke portion 1251, to allow the first vibration transmitting plate 125 to be connected to one end of the magnet assembly 1231 and one end of the magnetic conducting cover 1232, respectively, via the first inner fixing portion 1252 and the first outer fixing portion 1253. The second vibration transmitting plate 126 may include a second spoke portion 1261, and a second inner fixing portion 1262 and a second outer fixing portion 1263 connected to the second spoke portion 1261, to allow the second vibration transmitting plate 126 to be connected to another end of the magnet assembly 1231 and another end of the magnetic conducting cover 1232, respectively, via the second inner fixing portion 1262 and the second outer fixing portion 1263. The first spoke portion 1251 may include a plurality of first spokes spirally spreading outwards from a center of the first vibration transmitting plate 125, such as three first spokes shown in FIG. 8, to allow a region between the first inner fixing portion 1252 and the first outer fixing portion 1253 to be of a hollow structure so that the first vibration transmitting plate 125 has a preset elasticity coefficient. The second spoke portion 1261 may include a plurality of second spokes spirally spreading outwards from a center of the second vibration transmitting plate 126, such as three second spokes shown in FIG. 9, to allow a region between the second inner fixing portion 1262 and the second outer fixing portion 1263 to be of a hollow structure so that the second vibration transmitting plate 126 has a preset elasticity coefficient. Further, viewing along the vibration direction of the transducer 12, a helical direction of a first spoke of the first vibration transmitting plate 125 and a helical direction of a second spoke of the second vibration transmitting plate 126 are opposite to each other. The first spoke and the second spoke are in the same position. For example, the helical direction of the first spoke in FIG. 8 is clockwise while the helical direction of the second spoke in FIG. 9 is counterclockwise. In this way, when the coil 124 and the magnetic circuit system 123 have a tendency to torsion around the vibration direction of the transducer 12 during the vibration of the transducer 12, one of the first vibration transmitting plate 125 and the second vibration transmitting plate 126 may hinder the tendency, thereby avoiding unnecessary collisions, which is conducive to further reducing the magnetic gap of the magnetic circuit system 123.

Furthermore, in conjunction with FIG. 10, the first spoke portion 1251 may be further divided into a first sub-region 125A and a second sub-region 125B sleeved within each other along the radial direction of the first vibration transmitting plate 125. A helical direction of a first spoke in the first sub-region 125A is opposite to a helical direction of a first spoke in the second sub-region 125B. For example, the helical direction of the first spoke in the first sub-region 125A on an inner side in FIG. 10 is clockwise while the helical direction of the first spoke in the second sub-region 125B on an outer side is counterclockwise. In this way, when the coil 124 and the magnetic circuit system 123 have a tendency to torsion around the vibration direction of the transducer 12 during the vibration of the transducer 12, the first vibration transmitting plate 125 may hinder the tendency by itself since it has the first spokes whose inner and outer helical directions are opposite to each other, thereby avoiding unnecessary collisions, which is also conducive to further reducing the magnetic gap of the magnetic circuit system 123. The first vibration transmitting plate 125 may further include a first transition portion 1254, the first spoke in the first sub-region 125A and the first spoke in the second sub-region 125B are connected by the first transition portion 1254. Furthermore, in a circumferential direction of the first vibration transmitting plate 125, a connection point between any first spoke in the first sub-region 125A and the first transition portion 1254 may be located in the second sub-region 125B at a point between connection points between two adjacent first spokes and the first transition portion 1254.

Similarly, in conjunction with FIG. 11, the second spoke portion 1261 may be further divided into a third sub-region 126C and a fourth sub-region 126D sleeved with each other along the radial direction of the second vibration transmitting plate 126, and a helical direction of a second spoke in the third sub-region 126C is opposite to a helical direction of a second spoke in the fourth sub-region 126D. For example, the helical direction of the second spoke in the third sub-region 126C, which is on the inner side in FIG. 11, is counterclockwise, while the helical direction of the second spoke in the fourth sub-region 126D, which is on the outer side, is clockwise. In this way, when the coil 124 and the magnetic circuit system 123 have a tendency to torsion around the vibration direction of the transducer 12 during the vibration of the transducer 12, the second vibration transmitting plate 126 may hinder the tendency by itself since it has the first spokes whose inner and outer helical directions are opposite to each other, thereby avoiding unnecessary collisions, which is also conducive to further reducing the magnetic gap of the magnetic circuit system 123. The second vibration transmitting plate 126 may further include a second transition portion 1264, and the second spoke in the third sub-region 126C and the second spoke in the fourth sub-region 126D are connected by the second transition portion 1264. Further, in a circumferential direction of the second vibration transmitting plate 126, a connection point between any second spoke in the third sub-region 126C and the second transition portion 1264 may be located in the fourth sub-region 126D at a point between connection points between two adjacent second spokes and the second transition portion 1264.

Further, viewing along the vibration direction of the transducer 12, the first vibration transmitting plate 125 and the second vibration transmitting plate 126 may be set in a rectangular shape such that corners of both may be selectively partially removed to accommodate solder joints for lead wires of the coil 124.

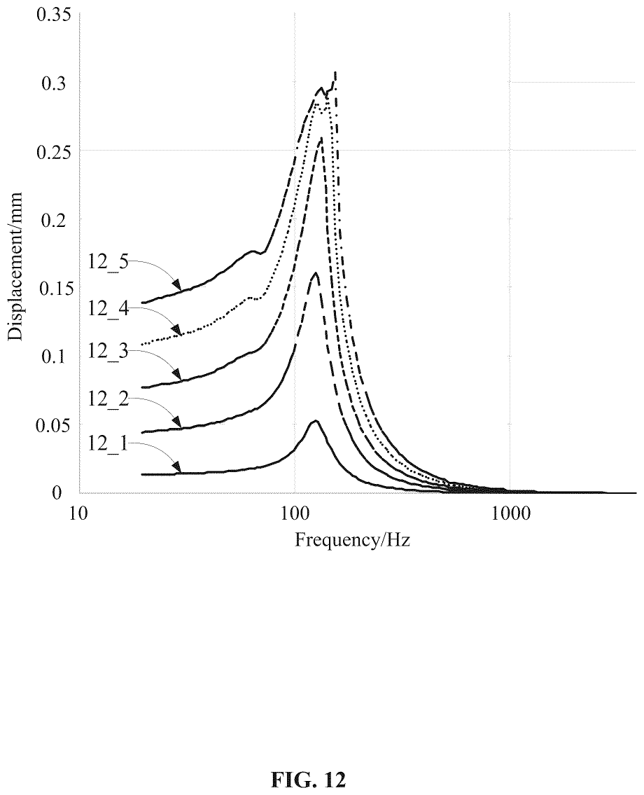

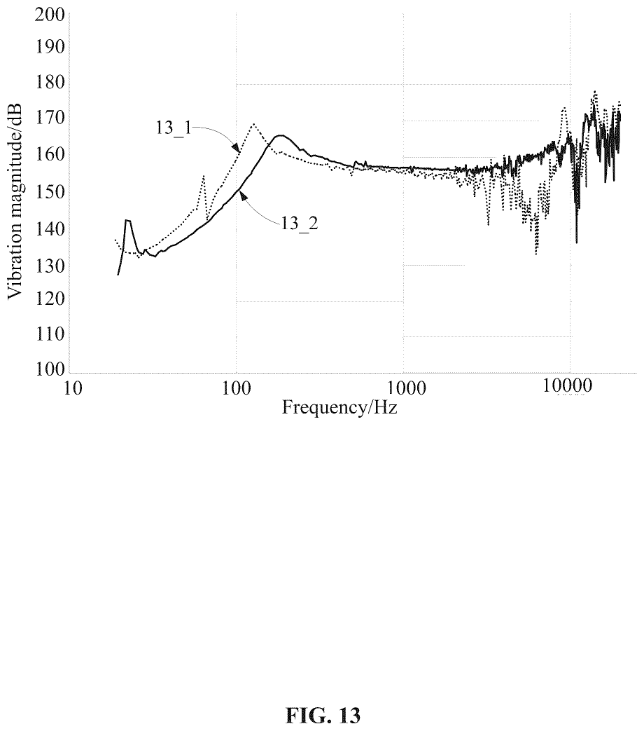

Referring together to FIG. 12 and FIG. 13, FIG. 12 is a schematic diagram illustrating vibration test results of a transducer according to an embodiment of the present disclosure. FIG. 13 is a schematic diagram illustrating frequency response curves of headphones according to some embodiments of the present disclosure.

In the embodiments in FIG. 3 to FIG. 6, the first vibration transmitting plate 125 and the second vibration transmitting plate 126 both elastically support the magnet assembly 1231 in the vibration direction of the transducer 12 from opposite sides of the magnet assembly 1231, respectively, making basic principles and related structures substantially the same. For convenience of description, one of the embodiments shown in FIG. 3 to FIG. 6 may be selected for exemplary illustration. For example, the transducer 12 in the embodiment in FIG. 3 is performed with a vibration test under different driving voltages, and the corresponding results of the vibration test are shown in FIG. 12. The driving voltages represented by Curves 12_1 to 12_5 in FIG. 12 are gradually increased. Specifically, the magnetic circuit system 123, the coil 124, the first vibration transmitting plate 125, and the second vibration transmitting plate 126 are first disassembled as a whole from the core module 10. The magnetic conducting cover 1232 is then fixed to a fixing table of a tester, such as a laser vibration tester, and the coil 124 can vibrate relative to the magnet assembly 1231. Then a driving voltage is input to the coil 124 to make the transducer 12 vibrate, and a displacement magnitude (i.e., an amplitude) of the magnet assembly 1231 during the vibration of the transducer 12 is measured based on a laser triangulation manner. Therefore, horizontal and vertical coordinates in FIG. 12 may be expressed as the frequency and the displacement magnitude, respectively. The unit of the frequency is Hz, and the unit of the displacement magnitude is mm.

In conjunction with FIG. 12, with the gradual increase of the driving voltage, the curves 12_1 to 12_5 are relatively smooth, which indicates that the vibration of the transducer 12 is stable, and there is no abnormal vibration such as obvious shaking. Besides, there is no significant change in a peak resonant frequency of a resonant peak of the transducer 12.

Further, the core housing 11 in the embodiment in FIG. 2 is fixed to the fixing table of the tester such as the laser vibration tester, and the vibration panel 13 can vibrate relative to the core housing 11. Similarly, when measuring a vibration displacement (i.e., an amplitude) of the vibration panel 13 during the vibration of the transducer 12 based on the laser triangulation manner, the vibration displacement of the vibration panel 13 may be converted into an acceleration of the vibration panel 13, which then may be converted into the vibration magnitude of the vibration panel 13 to obtain a frequency response curve of the vibration of the vibration panel 13. In other words, the curve 13_1 in FIG. 13 may represent the frequency response curve of the core module 10 in FIG. 2. The same test manner and its measurement condition may be used to obtain the frequency response curve of the core module 10 in the embodiment in FIG. 3, that is, the curve 13_2 in FIG. 13. In the present disclosure, the horizontal coordinate of the frequency response curve may represent the frequency, the unit of which is Hz. The vertical coordinate of the frequency response curve may represent the vibration magnitude, the unit of which is dB.

In conjunction with FIG. 13, the core module 10 shown in FIG. 3 has sufficient sensitivity, higher low-frequency resonance frequency, and superior high-frequency response compared to the core module 10 shown in FIG. 2.

The above descriptions are only a part of the embodiments of the present disclosure, which is not intended to limit the scope of protection of the present disclosure. Any equivalent device or equivalent process transformations utilizing the contents of the present disclosure and the accompanying drawings, or applying them directly or indirectly in other related technical fields, are similarly included in the scope of patent protection of the present disclosure.

What is claimed is:

1. A transducer, comprising a magnetic circuit system, a coil, a first vibration transmitting plate, and a second vibration transmitting plate, wherein
the magnetic circuit system includes a magnet assembly,
the coil is sleeved on an outside of the magnet assembly around an axis parallel to a vibration direction of the transducer, and
the first vibration transmitting plate and the second vibration transmitting plate elastically support the magnet assembly in the vibration direction from opposite sides of the magnet assembly, respectively.

2. The transducer of claim 1, wherein the magnet assembly includes a first magnet and a second magnet stacked along the vibration direction,
a magnetization direction of the first magnet and a magnetization direction of the second magnet are different,
a center region of the first vibration transmitting plate is connected to a side of the first magnet away from the second magnet, and
a center region of the second vibration transmitting plate is connected to a side of the second magnet away from the first magnet.

3. The transducer of claim 2, wherein the magnet assembly further includes a magnetic guiding plate clamped between the first magnet and the second magnet, and
when the coil is projected orthogonally to an outer peripheral surface of the magnet assembly in a direction perpendicular to the vibration direction, a projection of the coil overlaps with a lateral peripheral surface of the magnetic guiding plate.

4. The transducer of claim 3, wherein
the magnetization direction of the first magnet is opposite to the magnetization direction of the second magnet, and
the magnetization direction of the first magnet and the magnetization direction of the second magnet are perpendicular to a surface of the magnetic guiding plate towards the first magnet or the second magnet.

5. The transducer of claim 1, wherein the magnet assembly includes a magnet and a first magnetic guiding plate and a second magnetic guiding plate connected to two opposite sides of the magnet along the vibration direction,
a center region of the first vibration transmitting plate is connected to a side of the first magnetic guiding plate away from the second magnetic guiding plate, a center region of the second vibration transmitting plate is connected to a side of the second magnetic guiding plate away from the first magnetic guiding plate.

6. The transducer of claim 5, wherein in the vibration direction, a half-thickness location of the magnet is at a same height as a half-height location of the coil.

7. The transducer of claim 1, wherein the magnetic circuit system further includes a magnetic conducting cover sleeved on the outside of the coil around the axis,
an edge region of the first vibration transmitting plate is connected to an end of the magnetic conducting cover, and an edge region of the second vibration transmitting plate is connected to the other end of the magnetic conducting cover.

8. The transducer of claim 7, wherein in a direction perpendicular to the vibration direction, a gap between the coil and the magnetic conducting cover is smaller than a gap between the coil and the magnet assembly.

9. The transducer of claim 7, wherein a ratio of a height, in the vibration direction, of an overlapping region formed by orthographic projections of the magnet assembly, the coil, and the magnetic conducting cover along a direction perpendicular to the vibration direction to a height of the magnet assembly in the vibration direction is within a range of 0.15-0.5.

10. The transducer of claim 7, wherein a ratio of a height, in the vibration direction, of an overlapping region formed by orthographic projections of the magnet assembly, the coil, and the magnetic conducting cover along a direction perpendicular to the vibration direction to a height of the coil in the vibration direction is within a range of 0.53-0.83.

11. The transducer of claim 7, wherein a ratio of a height, in the vibration direction, of an overlapping region formed by orthographic projections of the magnet assembly, the coil, and the magnetic conducting cover along a direction perpendicular to the vibration direction to a height of the magnetic conducting cover in the vibration direction is within a range of 0.12-0.32.

12. The transducer of claim 1, wherein in natural states of the first vibration transmitting plate and the second vibration transmitting plate, an edge region of the first vibration transmitting plate is non-coplanar with a center region of the first vibration transmitting plate and an edge region of the second vibration transmitting plate is non-coplanar with a center region of the second vibration transmitting plate, to provide a preload force after the first vibration transmitting plate and the second vibration transmitting plate are connected to the first magnet and the second magnet, respectively.

13. The transducer of claim 12, wherein
a distance between the edge region of the first vibration transmitting plate and the center region of the first vibration transmitting plate in an axial direction of the first vibration transmitting plate is greater than or equal to 0.4, and
a distance between the edge region of the second vibration transmitting plate and the center region of the second vibration transmitting plate in the axial direction of the second vibration transmitting plate is greater than or equal to 0.4.

14. The transducer of claim 1, wherein in the vibration direction, a center region of the first vibration transmitting plate is further away from the magnet assembly compared to an edge region of the first vibration transmitting plate, and a center region of the second vibration transmitting plate is further away from the magnet assembly compared to an edge region of the second vibration transmitting plate.

15. The transducer of claim 14, wherein the magnetic circuit system further includes a connecting member threaded through the magnet assembly, a length of the connecting member in the vibration direction is greater than a thickness of the magnet assembly in the vibration direction, and the center region of the first vibration transmitting plate and the center region of the second vibration transmitting plate are fixed at two ends of the connecting member.

16. The transducer of claim 1, wherein
the first vibration transmitting plate includes a first spoke portion including a plurality of first spokes spirally spreading outwards from a center of the first vibration transmitting plate, and
the second vibration transmitting plate includes a second spoke portion including a plurality of second spokes spirally spreading outwards from a center of the second vibration transmitting plate, wherein
viewing along the vibration direction, a helical direction of a first spoke of the first vibration transmitting plate and a helical direction of a second spoke of the second vibration transmitting plate are opposite to each other, the first spoke and the second spoke are at a same position.

17. The transducer of claim 1, wherein
the first vibration transmitting plate includes a first spoke portion including a plurality of first spokes spirally spreading outwards from a center of the first vibration transmitting plate, wherein
the first spoke portion is divided into a first sub-region and a second sub-region sleeved with each other along a radial direction of the first vibration transmitting plate, and
a helical direction of a first spoke in the first sub-region is opposite to a helical direction of a first spoke in the second sub-region, and
the second vibration transmitting plate includes a second spoke portion including a plurality of second spokes spirally spreading outwards from a center of the second vibration transmitting plate, wherein
the second spoke portion is divided into a third sub-region and a fourth sub-region sleeved with each other along a radial direction of the second vibration transmitting plate, and
a helical direction of a second spoke in the third sub-region is opposite to a helical direction of a second spoke in the fourth sub-region.

18. A headphone, comprising a support assembly and a core module connected to the support assembly, wherein
the support assembly is configured to support the core module to be worn at a wearing position, and
the core module includes a core housing and a transducer, the transducer being provided in an accommodating cavity of the core housing, wherein
the transducer comprises a magnetic circuit system, a coil, a first vibration transmitting plate, and a second vibration transmitting plate, wherein
the magnetic circuit system includes a magnet assembly,
the coil is sleeved on an outside of the magnet assembly around an axis parallel to a vibration direction of the transducer, and
the first vibration transmitting plate and the second vibration transmitting plate elastically support the magnet assembly in the vibration direction from opposite sides of the magnet assembly, respectively.

19. The headphone of claim 18, wherein the core module further includes a vibration-damping sheet and a vibration panel,
the transducer is suspended in the accommodating cavity through the vibration-damping sheet,
the vibration panel is connected to the transducer and is configured to transmit mechanical vibration generated by the transducer to a user.

20. The headphone of claim 19, wherein
a ratio of a stiffness of the vibration-damping sheet to a stiffness of the first vibration transmitting plate is within a range of 0.1-5, and
a ratio of the stiffness of the vibration-damping sheet and a stiffness of the second vibration transmitting plate is within a range of 0.1-5.
